(19) United States
(12) Patent Application Publication
(10) Pub. No.: US 2016/0104953 A1
(43) Pub. Date: Apr. 14, 2016

(54) LUG WIRE-BINDING SCREW

(71) Applicant: SCHNEIDER ELECTRIC USA, INC., Schaumburg, IL (US)

(72) Inventor: Randy BLAKE, Vinton, IA (US)

(73) Assignee: SCHNEIDER ELECTRIC USA, INC., Schaumburg, IL (US)

(21) Appl. No.: 14/889,233

(22) PCT Filed: May 6, 2013
(86) PCT No.: PCT/US13/39742

§ 371 Date: Nov. 5, 2015

(51) Int. Cl. H01R 4/36

(52) U.S. Cl. CPC H01R 4/36

(57) ABSTRACT

An electrical connecting assembly includes a combination of a wire-binding screw and washer for fastening a conductor wire to a mechanical lug. The wire is inserted into the lug within a main bore. The screw and washer are inserted into the lug within a secondary threaded bore. The screw has a threaded body with an external thread for coupling to an internal thread of the mechanical lug. The threaded body has a bottom surface from which a boss extends with an end surface being formed-over for retaining the washer. The washer has a top surface in contact with the bottom surface of the screw and a bottom surface in contact with the conductor. The screw rotates independently of the washer, providing improved clamping force and reduced wire-strand breakage during current cycling.

### FIELD OF THE INVENTION

This invention is directed generally to electrical systems, and, more particularly, to a wire-binding screw with an independently rotating washer.

### BACKGROUND OF THE INVENTION

Circuit breakers are well known and commonly used to protect automatic circuit interruption to a monitored circuit when undesired conditions occurs. For example, a circuit breaker is designed to interrupt current flowing in the monitored circuit when it detects one or more of an overload condition, a ground fault condition, or a short-circuit condition.

Typically, a circuit breaker is electrically and physically connected to a load wire via a mechanical lug, which includes a wire-binding screw fastened to a conductor wire. The typical wire-binding screw is inserted and threaded into a bore of the mechanical lug until direct pressure is applied to the conductor wire. The direct pressure is intended to maintain the conductor wire fixed in place relative to the mechanical lug.

However, known conductor wires are made of soft materials, such as aluminum and copper, and are typically made in the form of individual bare strands. As such, the direct pressure applied with present wire-binding screws (which typically include pointed or sharp ends) to form an electrical connection tends to damage the conductor wires.

Another problem associated with present electrical connections is directed to relative movement between a conductor wire made from one material and the wire-binding screw made from a different material. Different materials typically have different rates of expansion and contraction and, accordingly, the life span and/or temperatures of a connection may lead to loose, inadequate connections between the parts involved.

What is needed, therefore, is a wire-binding screw with a connection configuration that addresses the above-stated and other problems.

### SUMMARY OF THE INVENTION

In an implementation of the present invention, an electrical connecting assembly includes a wire-binding screw and a washer. The wire-binding screw has a threaded body and a boss that extends from a bottom surface of the threaded body. The washer has an internal rim defining an aperture within which the boss is received, and a top surface in contact with the bottom surface of the wire-binding screw. The washer rotates independently of the wire-binding screw.

In another implementation of the present invention, a lug assembly for an electrical system includes a mechanical lug, a screw, and a Belleville washer. The mechanical lug has an unthreaded bore and a threaded bore, the threaded bore being in a transverse position relative to the unthreaded bore. The screw has a threaded body fastened within the threaded bore of the mechanical lug. The threaded body has a bottom surface from which a boss extends, the boss having a formed-over end near its bottom end. The formed-over end is formed after the Belleville washer is placed over the boss, with an internal rim being in contact with the boss . The formed-over end prevents axial movement of the washer past the bottom end of the screw. The washer is independently rotatable relative to the screw. As such, the formed-over end is not tight against the Belleville washer, allowing the Belleville washer to rotate, but prevents the Belleville washer from coming loose from the screw.

In another alternative implementation of the present invention, a wire-binding screw is formed with an integral boss to receive a Belleville washer. The boss extends from a bottom surface of a threaded body and has a formed-over end that retains the washer in place, with an internal rim of the washer being placed over the boss prior to forming the formed-over end. The threaded body is fastened into a threaded bore of a mechanical lug, with an external thread of the screw engaging an internal thread of the threaded bore. The screw is threaded inwards until a conductor wire, which is inserted into the lug through an unthreaded bore, is secured in place relative to the lug. The washer has a top surface in contact with the bottom surface of the screw and a bottom surface in contact with the wire. The screw rotates independently of the washer to improve the wire clamping force for a given torque and during current cycling. In other words, the combination of only the screw and washer reduces loose wire connections that would otherwise occur during normal use as a result of vibration forces and/or temperature changes caused by the current cycling in the lug. The independent rotation is beneficial at least because it reduces friction between the screw and the wire, which, in turn, reduces wire strand breakage (especially when the wire includes fine wire strands).

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The invention may best be understood by reference to the following description taken in conjunction with the accompanying drawings.

FIG. 1A is an isometric exploded view of an electrical assembly with a mechanical lug, a conductor wire, and a connecting assembly.

FIG. 1B is an isometric assembled view of the electrical assembly of FIG. 1A.

FIG. 2 is a front exploded view of the connecting assembly of FIG. 1A.

FIG. 3 is a cross-sectional view along lines “3-3” of FIG. 2.

FIG. 4 is an isometric assembled view of the connecting assembly of FIG. 1A.

FIG. 5 is a cross-sectional view along lines “5-5” of FIG. 4.

FIG. 6 is a cross-sectional view showing the electrical assembly in assembled form with the connecting assembly in contact with the conductor wire.

### DETAILED DESCRIPTION OF THE ILLUSTRATED EMBODIMENTS

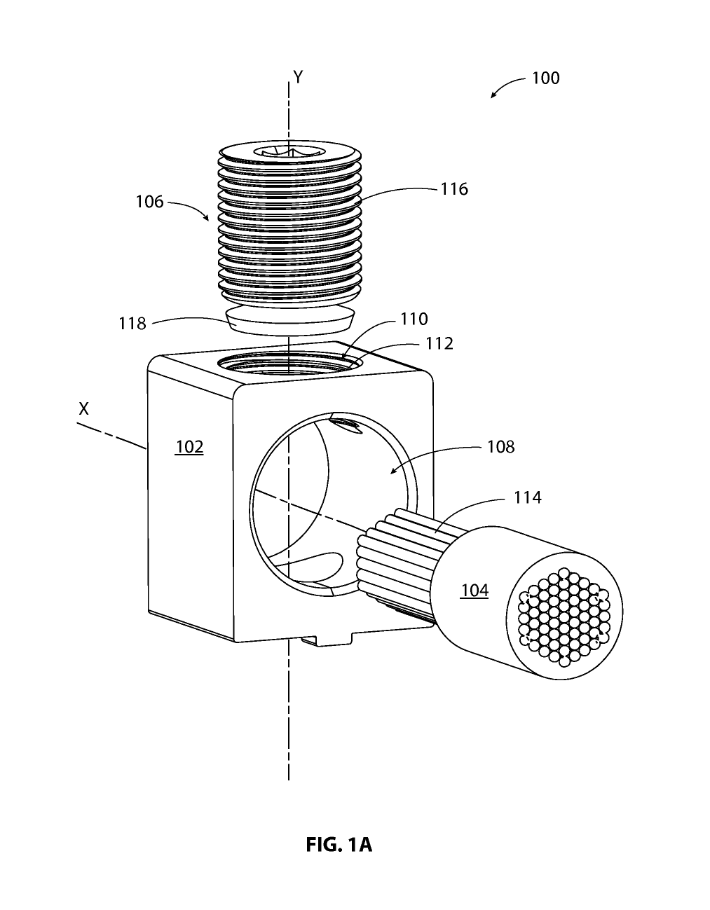

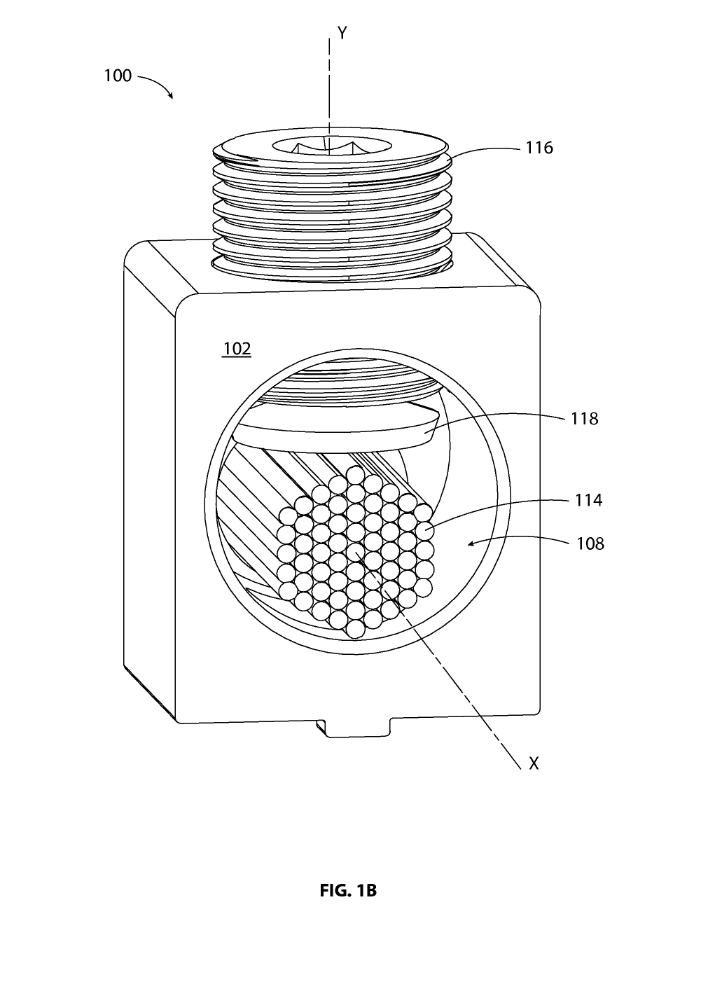

Referring to FIGS. 1A and 1B, an electrical assembly 100 includes a mechanical lug 102, a conductor wire 104, and a connecting assembly 106. The mechanical lug 102 has a primary bore 108 with a central axis X and a secondary bore 110 with a central axis Y, which is in a transverse direction relative to axis X. The primary bore 108 is unthreaded and is configured to receive the conductor wire 104. Specifically, the primary bore 108 permits introduction of the conductor wire 104 into and/or through the mechanical lug 102. The secondary bore 110 has an internal thread 112 and is configured to receive the connecting assembly 106. As such, the secondary bore 108 permits the introduction and attachment of the connecting assembly 106 into and/or through the mechanical lug 102 in a transverse direction relative to the conductor wire 104. In this exemplary embodiment, the mechanical lug 102 is rectangular and the bores 108, 110 are circular. It is understood, however, that other lug or primary bore shapes are similarly contemplated.

The conductor wire 104 includes a bundle of wire strands 114 that are oriented parallel to the central axis X. After insertion of the conductor wire 104 into the primary bore 108, the connecting assembly 106 is threaded into the secondary bore 110 until direct contact is made and pressure is applied to the wire strands 114, thereby fixing in place the conductor wire 104 relative to the mechanical lug 102.

The connecting assembly 106 includes a wire-binding screw 116 with a coupled, but independently rotatable, washer 118. Together, the wire-binding screw 116 and the coupled washer 118 help achieve a connection that, as explained in more detail below, help reduce loose wire connections and breakage of the wire strands 114.

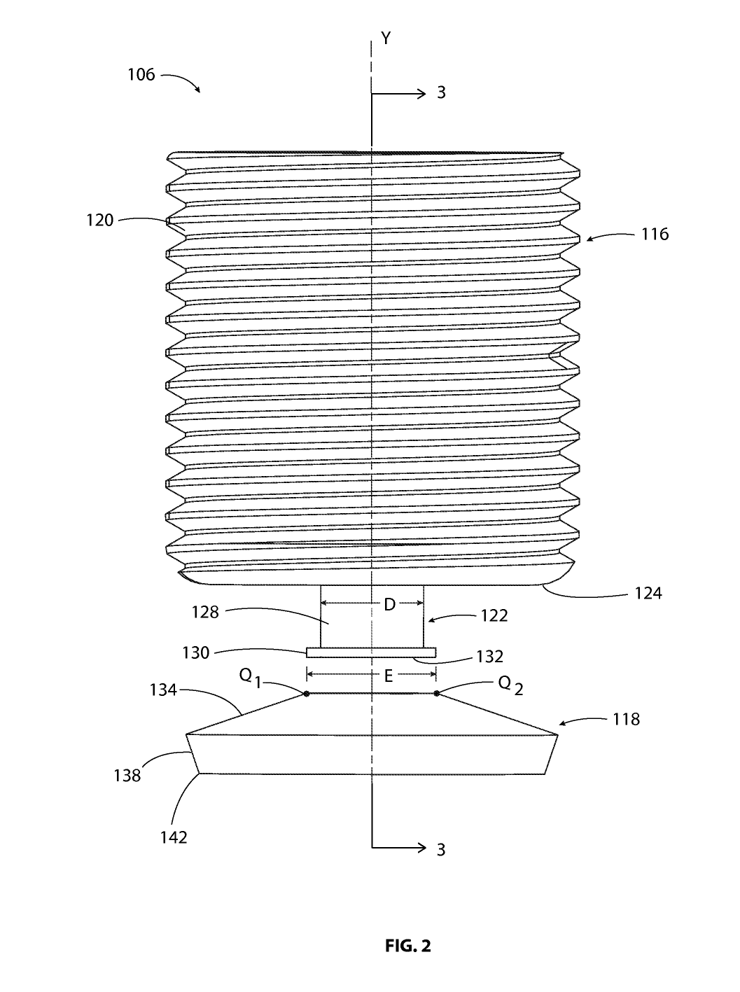

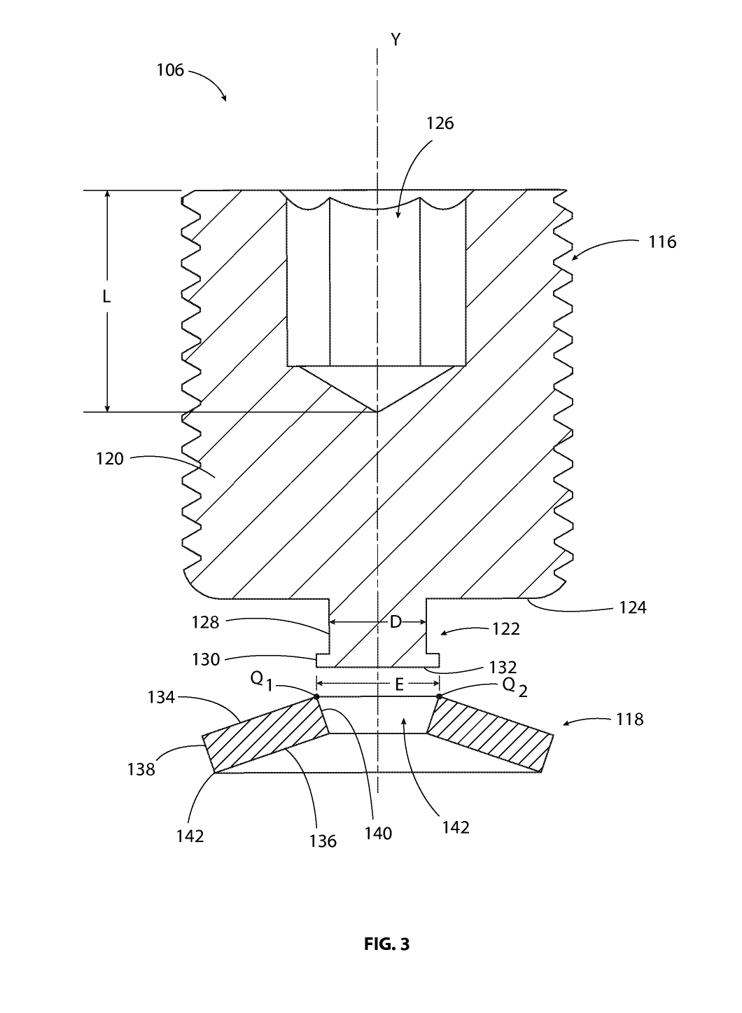

Referring to FIGS. 2 and 3, the connecting assembly 106 is illustrated with the washer 118 de-coupled from the wire-binding screw 116. The wire-binding screw 116 has an externally threaded body 120 and a boss 122, which extends from a bottom surface 124 of the threaded body 120. The threaded body 120 includes a hole 126 (FIG. 3) in a top portion for receiving a fastening tool, such as a screwdriver. The hole 126 extends from a top surface 126 of the threaded body 120 a distance L towards the bottom surface 124.

The boss 122 has a longitudinal body 128 extending along the central axis Y and having a diameter D. The longitudinal body 128 includes a formed-over end 130 with a diameter E near a bottom surface 132. As such, the formed-over end 130 extends radially from the central axis Y along the bottom surface 132 of the boss 122. As explained in more detail below, the diameter E of the formed-over end 130 is slightly larger than the diameter D of the longitudinal body 128 to provide a connection such that the wire-binding screw 116 capture and retains the washer 118. The formed-over end 130 is formed after the washer 118 is placed over the boss 122.

According to the illustrated example, the wire-binding screw 116 is a modified set screw. Usually, a set screw is headless and is driven with an internal-wrenching drive, such as a hex socket, or a slot drive. The typical set screw exerts compressional or clamping force through a bottom end. The connection achieved with the present wire-binding screw 116, however, prevents the most-bottom end of the wire-binding screw 116 (i.e., the bottom surface 132 of the boss 122) for exerting a compressional force on the conductor wire 104. Instead, the compressional force is exerted by the independently rotatable washer 118.

The washer 118 has a top surface 134 joined to a bottom surface 136 (FIG. 3) via an exterior wall 138. An internal wall or rim 140 (FIG. 3) defines an aperture 142 (FIG. 3) within which the boss 122 is received, when the washer 118 is coupled to the boss 122. The washer 118 is spring-formed such that the top and bottom surfaces 134, 136 are bendable and angled relative to an outer periphery edge 142. Thus, the bottom surface 136 is curved inwards towards the wire-binding screw 116, with only the outer periphery being configured to make direct contact with the conductor wire 104.

According to the illustrated example, the washer 118 is a Belleville washer. In other words, the washer 118 is a coned-disc spring, with a frusto-conical shape, that applies a pre-load or flexible quality to the connection between the wire-binding screw 116 and the conductor wire 104. The Belleville washer provides an increased fatigue life, better space utilization, a low-creep tendency, and a high-load capacity with a small spring deflection.

In the examples described above, the boss 122 and the aperture 142 have a circular shape. It is understood that in other examples, the boss 122 and the aperture 142 can have different shapes (e.g., elliptical) that will allow independent rotation between the washer 118 and the wire-binding screw 116.

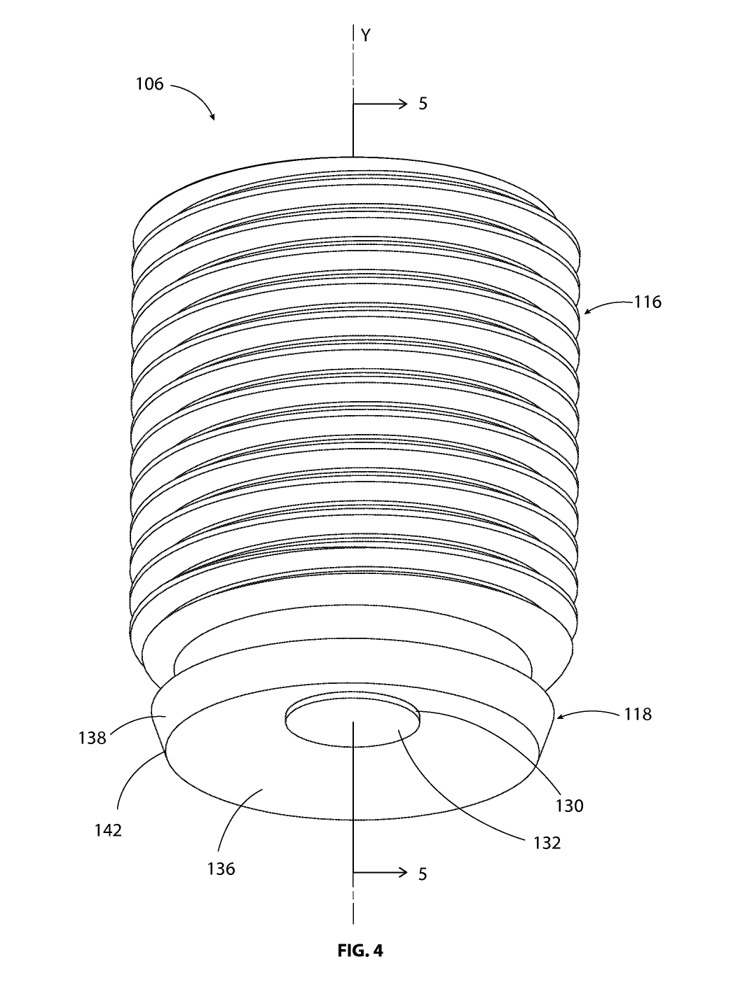

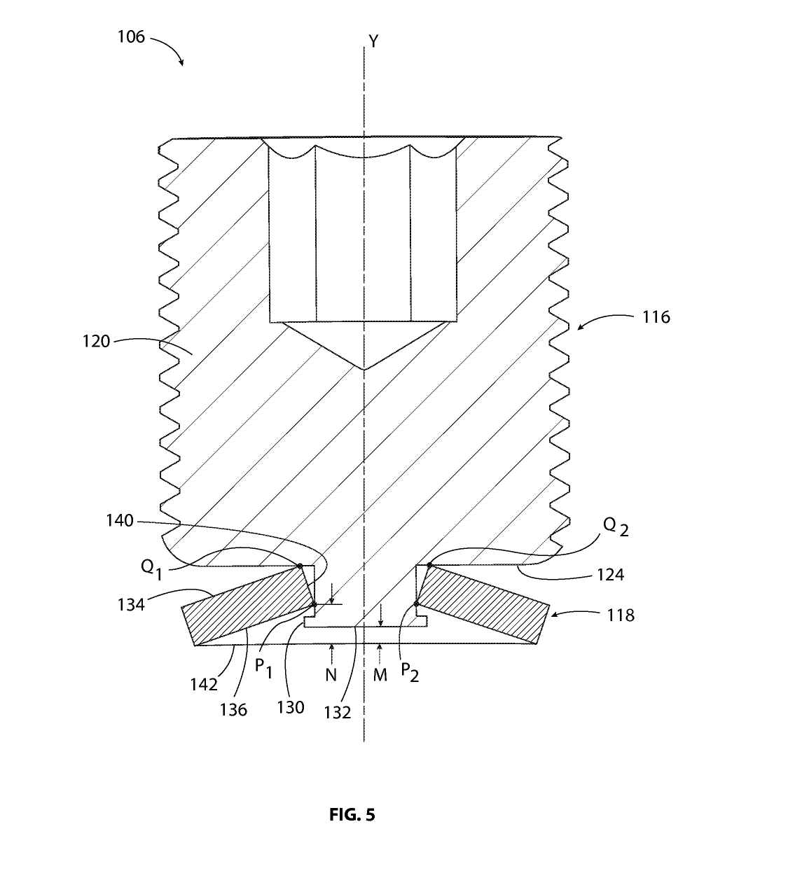

Referring to FIGS. 4 and 5, the connecting assembly 106 is illustrated with the washer 118 being coupled with the wire-binding screw 116. When coupled, the points of contact between the wire-binding screw 116 and the washer 118 occur at top intersection points Q1, Q2, which are the intersection points between the top surface 134 of the washer 118 and the internal rim 140. Furthermore, as shown, the periphery edge 142 is dimensioned to be, along the central axis Y, a distance M away from the bottom surface 132 of the boss 122. The periphery edge 142 is also dimensioned to be a distance N away from bottom intersection points P1, P2 between the internal rim 140 and the bottom surface 136 of the washer 118.

To couple the washer 118 with the wire-binding screw 116, the washer 118 is placed over the boss 122 and pressed towards the wire-binding screw 116. Initially, prior to placing the washer 118 over the boss 122, the longitudinal body 128 of the boss 122 has a diameter D that extends down to the bottom surface 132 of the boss 122. In other words, the formed-over end 130 does not exist, yet. After the washer 118 has been placed over the boss 122, and past the bottom surface 132, the end of the boss 122 (i.e., near the bottom surface 132) is formed with a machine to add the formed-over end 130 with the increased diameter E. The formed-over end 130 prevents the washer 118 from being de-coupled from (or coming loose from) the wire-binding screw 116, while simultaneously allowing independent rotational movement of the washer 118 relative to the wire-binding screw 116.

When coupled with the wire-binding screw 116, the washer 118 is free to translate and rotate relative to the wire-binding screw 116. In reference to the translational motion, the washer 118 is free to move a small distance axially, along the central axis Y, between the bottom surface 124 of the wire-binding screw 116 and the formed-over end 130. Specifically, in one direction, axial movement is limited at the top intersection points Q1, Q2 when contact is made between the washer 118 and the bottom surface 124 of the wire-binding screw 116. In an opposite direction, axial movement is limited at the bottom intersection points P1, P2 when contact is made between the washer 118 and the formed-over end 130. In alternative embodiments, the translation motion is not required, with the washer 118 being completely fixed in place along the central axis Y between the bottom surface 124 of the wire-binding screw 116 and the formed-over end 130. Optionally, the washer 118 bends until its top surface 134 is flush with the bottom surface 124 of the threaded body 120.

In reference to the rotational motion, the washer 118 is independently rotatable relative to the wire-binding screw 116 and with respect to the central axis Y. As discussed in more detail below, the independent rotation is beneficial to improve connections between the wire-binding screw 116 and the conductor wire 104.

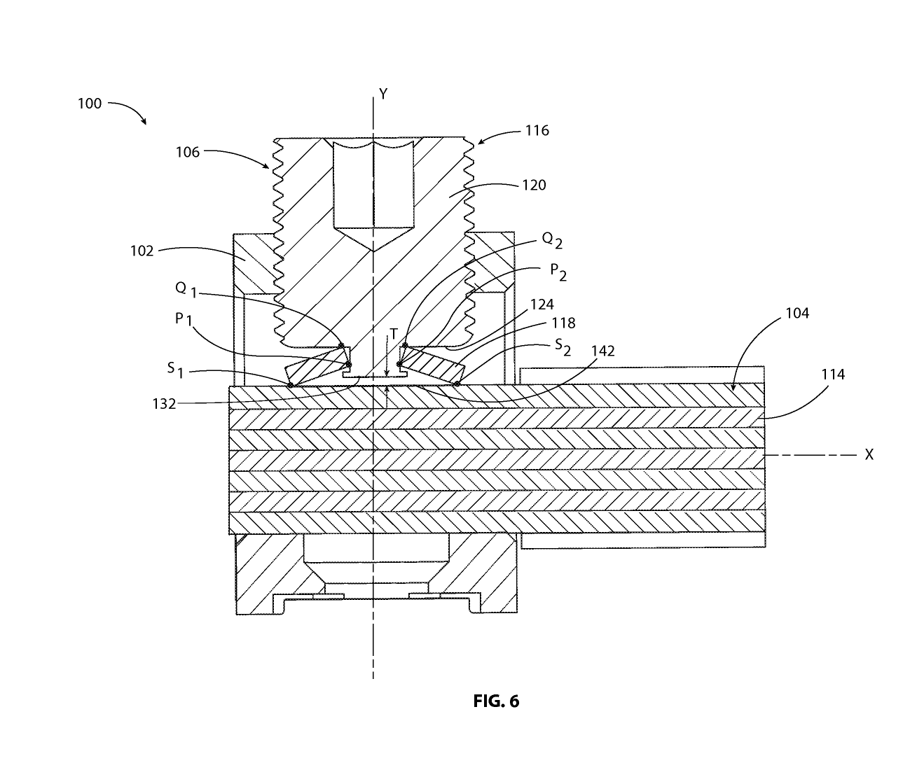

Referring to FIG. 6, a cross-sectional view shows the electrical assembly 100 with the connecting assembly 106 exerting pressure on the conductor wire 104. Specifically, as shown, the wire-binding screw 116 has been threaded into the mechanical lug 102 until the periphery edge 142 has made direct contact with the conductor wire 104. The only contact between the connecting assembly 106 and the conductor wire 104 is along the periphery edge 142, which is better illustrated by referring to points of contact S1, S2.

The exerted pressure can be fine tuned in according with the spring force of the Belleville washer 118 that can flex along central axis Y. The contact points Q1, Q2 and the contact points P1, P2 help pivot and adjust the spring force of the Belleville washer 118 relative to the contact points S1, S2. However, a gap distance T is maintained between the bottom surface 132 of the boss 122 and the conductor wire 104 to prevent direct contact between the wire-binding screw 116 and the conductor wire 104. As such, the bottom surface 132 of the boss 122 is prevented from damaging the conductor wire 104, and, more specifically, the wire strands 114.

Direct contact between the bottom surface 132 of the boss 122 and the conductor wire 104 would, otherwise, unavoidably and unnecessarily deform and/or damage the wire strands 114, especially when relative movement occurs between the wire-binding screw 116 and the conductor wire 104. The relative movement may occur during fastening and/or unfastening of the conductor wire 1044 into the mechanical lug 102, during temperature cycling, and/or normal vibration operational forces.

Another benefit of the connecting assembly 106 is that the Belleville washer 118 can rotate independent of the wire-binding screw 116. Without the independent movement of the Belleville washer 118, the fixed wire-binding screw 116 and the fixed conductor wire 104 would cause damaging strain to one or more of the components, and, most likely, to the conductor wire 104. As such, relative movement between the wire-binding screw 116 and the conductor wire 104 is flexibly facilitated by the Belleville washer 118. For example, expansion of the conductor wire 104 will simply result in compression of the Belleville washer 118 towards the threaded body 120, while contraction of the conductor wire 104 will result in expansion of the Belleville washer 118 in an opposite direction, away from the threaded body 120.

Regardless, the relative movement does not adversely affect the conductor wire 104 because the Belleville washer 118 accommodates the movement (i.e., provides minimum contact friction for moving with the moving component, instead of attempting to prevent the motion). Accordingly, the connecting assembly 106 reduces wire-strand breakage and improves wire-clamping force during current cycling for a given torque, based on reduced friction and based on independent rotation between the wire-binding screw 116 and the Belleville washer 118.

While particular embodiments, aspects, and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. An electrical connecting assembly comprising:
a wire-binding screw having a threaded body and a boss, the boss extending from a bottom surface of the threaded body; and
a washer having an internal rim defining an aperture within which the boss is received, the washer having a top surface in contact with the bottom surface of the wire-binding screw, the washer rotating independently of the wire-binding screw.

2. The assembly of claim 1, wherein the threaded body is in the form of a headless screw.

3. The assembly of claim 1, wherein the washer is a Belleville washer.

4. The assembly of claim 1, wherein a bottom surface of the washer is curved inwards towards the wire-binding screw, with only an outer periphery being configured to make direct contact with a conductor wire.

5. The assembly of claim 1, wherein the top surface of the washer is flush with the bottom surface of the wire-binding screw.

6. The assembly of claim 1, wherein the boss includes a formed-over end for retaining the washer.

7. The assembly of claim 6, wherein the formed-over end of the boss extends radially along a bottom surface of the boss.

8. The assembly of claim 1, wherein the boss of the wire-binding screw and the aperture of the washer have a circular shape.

9. The assembly of claim 1, wherein a bottom surface of the boss is configured such that direct contact with a conductor wire is prevented.

10. A lug assembly for an electrical system, the assembly comprising:
a mechanical lug having an unthreaded bore and a threaded bore, the threaded bore being in a transverse position relative to the unthreaded bore;
a screw having a threaded body fastened within the threaded bore of the mechanical lug, the threaded body having a bottom surface from which a boss extends, the boss having a formed-over end near its bottom end; and
a Belleville washer directly coupled to the screw with an internal rim in contact with the boss and pressed past the formed-over end, the formed-over end preventing axial movement of the washer past the bottom end of the screw, the washer being independently rotatable relative to the screw.

11. The assembly of claim 10, wherein the threaded body is in the form of a headless screw.

12. The assembly of claim 10, wherein the bottom surface of the washer is curved inwards towards the screw.

13. The assembly of claim 1, wherein a top surface of the washer is in direct contact and flush with the bottom surface of the screw.

14. The assembly of claim 10, wherein the formed-over end of the boss extends radially outward along a bottom surface of the boss.

15. The assembly of claim 10, wherein the boss of the screw and the internal rim of the washer have a circular shape.
